(19) United States
(12) Patent Application Publication
(10) Pub. No.: US 2016/0020690 A1
(43) Pub. Date: Jan. 21, 2016

(54) SIGNAL GENERATOR AND PFC CONVERTER USING THE SAME

(71) Applicant: SAMSUNG ELECTRO-MECHANICS CO., LTD., Suwon-si (KR)

(72) Inventors: Man Dong LEE, Suwon-Si (KR); Jeong Mo YANG, Suwon-Si (KR); Joon Youp SUNG, Suwon-Si (KR); Hwan CHO, Suwon-Si (KR)

(73) Assignee: SAMSUNG ELECTRO-MECHANICS CO., LTD., Suwon-si (KR)

(21) Appl. No.: 14/802,523

(22) Filed: Jul. 17, 2015

(30) Foreign Application Priority Data
Jul. 21, 2014 (KR) 10-2014-0091825

(51) Int. Cl. H02M 1/42; H02M 1/08

(52) U.S. Cl. CPC H02M 1/42; H02M 1/08; H02M 2001/0012

(57) ABSTRACT

Disclosed herein are a signal generator having high efficiency and a PFC converter using the same. According to an exemplary embodiment of the present disclosure, a PFC converter includes: a converter unit including an inductor and a switch which switches a flow of driving current in the inductor by a turn on or turn off operation; and a signal generator outputting a turn on signal or a turn off signal switching the switch and when a magnitude of the driving current is smaller than a preset value, keeping the turn on signal long to enable the magnitude of the driving current to reach the preset value.

This application claims the benefit under 35 U.S.C. Section [120, 119, 119(e)] of Korean Patent Application Serial No. 10-2014-0091825, entitled “Signal Generator and PFC Converter Using the Same” filed on Jul. 21, 2014, which is hereby incorporated by reference in its entirety into this application.

### BACKGROUND OF THE INVENTION

1. Technical Field

The present invention relates to a signal generator and a PFC converter using the same.

2. Description of the Related Art

A switching mode power supplier has adopted a power factor correction (PFC) converter. The PFC converter may compensate for a power factor by letting an input current track an input voltage. That is, the PFC converter may output an AC voltage as a constant DC voltage while letting the input current track the input voltage applied to the outside.

Recently, the power supplier lays emphasis on improvement in efficiency in a heavy load state and a light load state. However, the PFC converter has a problem of reduction in efficiency in the light load as a switching frequency is increased.

### SUMMARY OF THE INVENTION

An object of the present invention is to provide a signal generator having high efficiency and a PFC converter using the same.

According to an exemplary embodiment of the present invention, there is provided a PFC converter, including: a converter unit including an inductor and a switch which switches a flow of driving current in the inductor by a turn on or turn off operation; and a signal generator outputting a turn on signal or a turn off signal switching the switch and when a magnitude of the driving current is smaller than a preset value, keeping the turn on signal long to enable the magnitude of the driving current to reach the preset value.

According to another exemplary embodiment of the present invention, there is provided a signal generator controlling a turn on signal and a turn off signal to control a flow of driving current, including: an on signal generator outputting an on trigger signal in response to a sensing voltage sensing the driving current; an off signal generator outputting the off trigger signal in response to the sensing voltage; and a latch circuit outputting the turn on signal when the on trigger signal is input and outputting the turn off signal when the off trigger signal is input, wherein the off signal generator delays the off trigger signal when a magnitude of the sensing voltage is smaller than a preset value and transfers the delayed off trigger signal to the latch circuit to enable the magnitude of the sensing voltage to reach the preset value.

According to still another exemplary embodiment of the present invention, there is provided a signal generator controlling a turn on signal and a turn off signal to control a flow of driving current, including: a first comparator comparing a sensing voltage sensing the driving current with a first reference voltage; a second comparator comparing the sensing voltage with a second reference voltage; a third comparator comparing a ramp signal having a predetermined slope with a third reference voltage; a first operator receiving output signals of the first comparator and the third comparator to perform an AND operation and outputting a signal corresponding to a turn off signal when the sensing voltage is higher than the first reference voltage and a magnitude of the ramp signal is larger than the third reference voltage; a capacitor having a first electrode receiving a current signal corresponding to the ramp signal and a second electrode connected to a predetermined voltage source and reset by a reset switch; a fourth comparator having a positive (+) input terminal and a negative (−) input terminal connected to one terminal and the other terminal of the capacitor, respectively and generating a signal corresponding to a turn on signal when a voltage charged in the capacitor is lower than a predetermined value in the state in which the reset switch is turned off; a latch circuit receiving a voltage of an output terminal of the first operator and a voltage of an output terminal of the fourth comparator and selectively outputting the voltages of the output terminals; and a second operator being fed back with an output signal of the latch circuit and receiving an output signal of the fourth comparator to perform a NOR operation.

### BRIEF DESCRIPTION OF THE DRAWINGS

FIG. 1 is a circuit diagram of a PFC converter according to an exemplary embodiment of the present invention.

FIG. 2 is a waveform diagram illustrating a current flowing from a typical PFC converter toward an inductor.

FIG. 3 is a waveform diagram illustrating indicating a current flowing from the PFC converter illustrated in FIG. 1 toward the inductor.

FIG. 4 is a structure diagram illustrating a first exemplary embodiment of a signal generator which is adopted in the PFC converter illustrated in FIG. 1.

FIG. 5 is a diagram illustrating a timing when gate signals are generated by an on trigger signal and an off trigger signal in a latch circuit illustrated in FIG. 4.

FIG. 6 is a structure diagram illustrating a second exemplary embodiment of a signal generator which is adopted in the PFC converter illustrated in FIG. 1.

FIG. 7 is a waveform diagram illustrating a waveform of a ramp signal which is output from a lamp signal generator illustrated in FIG. 6.

FIG. 8 is a waveform diagram illustrating a waveform of current which is output from a current signal generator illustrated in FIG. 6.

FIG. 9 is a waveform diagram indicating a magnitude of current flowing from the PFC converter illustrated in FIG. 1 toward the inductor.

### DESCRIPTION OF THE PREFERRED EMBODIMENTS

Matters of an action effect and a technical configuration of a signal generator and a PFC converter using the same according to an exemplary embodiment of the present invention to achieve the above object will be clearly obvious by the following detailed description with reference to the drawings which illustrate exemplary embodiments of the present invention.

Further, when it is determined that the detailed description of the known art related to the present disclosure may obscure the gist of the present disclosure, the detailed description thereof will be omitted. In the present specification, the terms first, second, and so on are used to distinguish one element from another element, and the elements are not defined by the above terms.

Exemplary embodiments of the present disclosure will be described in detail with reference to the accompanying drawings illustrating an example of specific exemplary embodiments which may be practiced by the present invention. These exemplary embodiments will be described in detail for those skilled in the art in order to practice the present disclosure. It should be appreciated that various exemplary embodiments of the present disclosure are different from each other, but do not have to be exclusive. For example, specific shapes, structures, and characteristics described in the present specification may be implemented in another exemplary embodiment without departing from the spirit and the scope of the present disclosure in connection with an exemplary embodiment. In addition, it should be understood that a position or an arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings in various aspects.

Hereinafter, exemplary embodiments of the present disclosure will be described in detail with reference to the accompanying drawings so that those skilled in the art may easily practice the present disclosure.

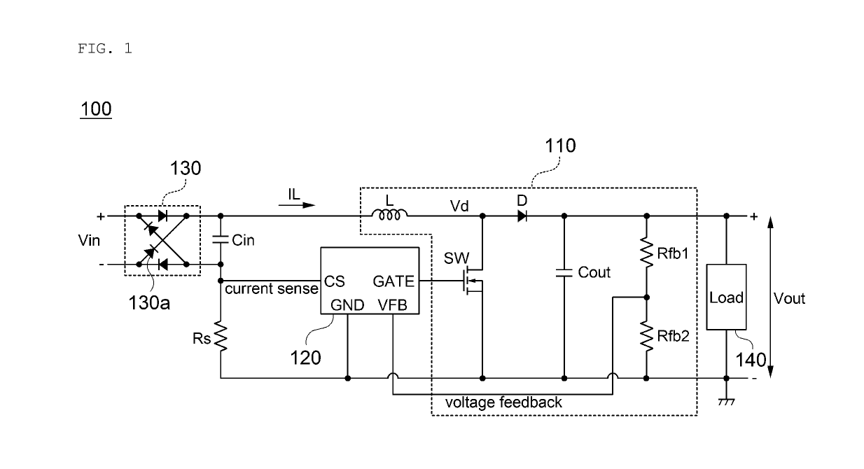

FIG. 1 is a circuit diagram of a PFC converter according to an exemplary embodiment of the present invention.

Referring to FIG. 1, a PFC converter 100 may include a converter unit 110 including an inductor L and a switch SW which switches a flow of driving current IL in the inductor L by a turn on or turn off operation; and a signal generator 120 outputting a turn on signal or a turn off signal and when a magnitude of the driving current IL flowing in the inductor L is smaller than a preset value, keeping the turn on signal long to enable the magnitude of the driving current IL to reach the preset value. In this configuration, the switch SW may be an FET, a MOS transistor, a BJT, and the like, but is not limited thereto.

Further, the converter unit 110 may further include a rectifier 130 which performs full-wave rectification on an AC current supplied from input power supply voltage Vin. Further, the inductor L may receive the driving current IL from the rectifier 130. According to the exemplary embodiment of the present invention, the rectifier 130 may include bridge diodes 130a and a rectifier capacitor Cin. The rectifier 130 may use the bridge diode 130a to perform the full-wave rectification on the AC current supplied from the input power supply voltage Vin and may charge the full-wave rectified AC current in the rectifier capacitor Cin. Further, the converter unit 110 may have the inductor L connected to the diode D to prevent a reverse current from flowing in the inductor L.

The signal generator 120 may output a gate signal ‘gate’ depending on a sensing voltage VCS and a feedback voltage VFB, in which the gate signal ‘gate’ may include a turn on signal and a turn off signal.

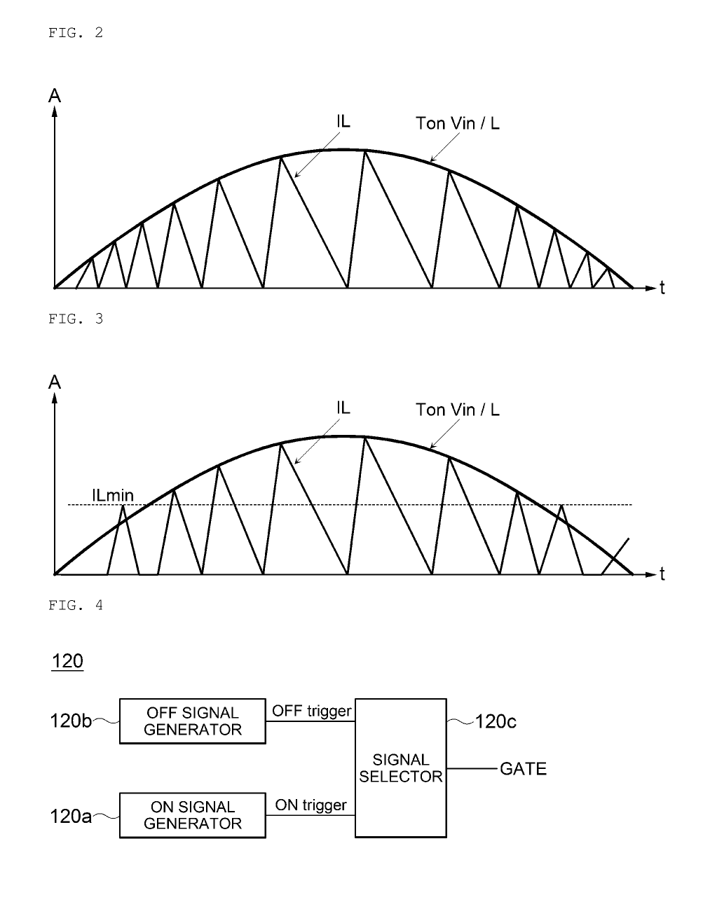

The signal generator 120 outputs a turn on signal ‘ON’ to turn on the switch SW so as to enable the driving current IL to flow from the rectifier 130 toward the switch SW through the inductor L and outputs the turn off signal ‘OFF’ to turn off the switch SW so as to enable the driving current IL to flow from the rectifier 130 toward the load 140 through the inductor L. The turn on signal ‘ON’ may be a high-state signal and the turn off signal ‘OFF’ may be a low-state signal but these signals are not limited thereto. Therefore, if the turn on signal ‘ON’ turns on the switch SW and the turn off signal ‘OFF’ turns off the switch SW, these signals may be a signal in any state. In this case, the sensing voltage VCS may be a voltage which appears in a sensing resistance Rs in response to the driving current IL flowing in the load 140 and the feedback voltage VFB may be a voltage corresponding to a voltage applied to the load 140. Further, the feedback voltage VFB may be a voltage divided by a first resistor Rfb1 and a second resistor Rfb2 which are connected to the load 140 in parallel. Further, a current flows in the inductor L or is reduced by the turn on or turn off operation of the switch SW, and thus as illustrated in FIG. 2, the driving current IL flowing in the inductor L may have a sawtooth wave form. Here, the sawtooth wave form is for description and the switching operation of the switch SW may very rapidly performed in the PFC converter 100 and the number of sawtooth waves may more appear. Further, if a line connecting peak values of the driving current IL having a sawtooth wave form meets the following Equation 1, a power factor of the PFC converter 100 may be improved.

IL=Ton×Vin/L [Equation 1]

Further, if the peak value of the driving current IL flowing in the inductor L meets the above Equation 1, an average value of the driving current IL flowing in the inductor L may meet the following Equation 2.

∫₀^{Tov×Vin/}2L [Equation 2]

In the above Equation 2, IL represents the driving current flowing in the inductor L, ∫₀^{Tov}ILdt/Tov represents the average value of the driving current IL flowing in the inductor L at one period of switching, Ton represents the time for which the switch SW keeps a turn on state, Tsw represents a timing when the switch SW is again turned on, and Vin represents a magnitude of input power supply voltage Vin, and L represents a size of the inductor L.

When the current flowing in the inductor L by the operation of the switch SW meets the above Equation 1, in particular, when in a light load, the turn on time of the switch SW is small and the magnitude of the input power supply voltage Vin is small, the peak value of the driving current IL is small and thus energy is not transferred but may be merely consumed, such that the efficiency of the PFC converter 100 may be reduced. Therefore, to solve the above problem, the signal generator 120 keeps the turn on signal ‘ON’ of the switch SW long when the magnitude of the sensing voltage VCS does not reach a value which is preset by the above Equation 1 to make the time for which the driving current IL flows longer, thereby enabling the magnitude of the driving current IL to reach the preset value. Here, the preset value may be changed depending on electronics (not illustrated) in which the PFC converter 100 is adopted. Further, the magnitude of the driving current IL may reach the preset value by controlling the time for which the turn on state of the switch SW is maintained, but when the time for which the switch SW maintains the turn off state is not changed, there may be a problem in that the average value of the driving current IL flowing in the inductor L may not meet the above Equation 2. To solve the above problem, the signal generator 120 may keep the turn off signal ‘OFF’ long, in which the turn off signal is continued to the turn on signal ‘ON’ kept long to enable the average value of the driving current IL flowing in the inductor L to meet the above Equation 2. That is, the current flowing in the inductor L may be represented as illustrated in FIG. 3 and thus the driving current IL flowing in the inductor L may reach the preset value. In this case, a method for enabling the switch SW to keep the turn on state long may be achieved by delaying the time for which the turn on signal ‘ON’ is generated and then the turn off signal ‘OFF’ is generated. Further, a method for enabling the switch SW to keep the turn off state long may be achieved by delaying the time for which the turn off signal ‘OFF’ is generated and then the turn on signal ‘ON’ is generated. Here, a section in which the switch SW is turned off and thus the driving current IL is represented by “0” may be a resonance waveform having a small amplitude due to parasitic capacitance of the inductor L and the switch SW in the actual PFC converter 100.

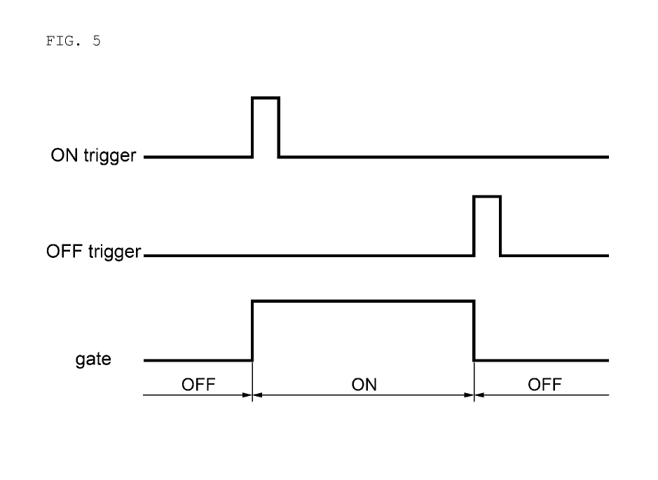

FIG. 4 is a structure diagram illustrating a first exemplary embodiment of a signal generator which is adopted in the PFC converter illustrated in FIG. 1 and FIG. 5 is a diagram illustrating a timing when gate signals are generated by an on trigger signal ‘ON trigger’ and an off trigger signal ‘off trigger’ in a latch circuit illustrated in FIG. 4.

Referring to FIG. 4, the signal generator 120 may include an on signal generator 120a which generates an on trigger signal ‘ON trigger’ and an off signal generator 120b which generates an off trigger signal ‘OFF trigger’. Further, the signal generator 120 may include a latch circuit 120c which outputs the turn on signal ‘ON’ after the on trigger signal ‘ON trigger’ is input and before the off trigger signal is input and outputs the turn off signal ‘OFF’ after the off trigger signal ‘OFF trigger’ is input and before the on trigger signal ‘ON trigger’ is input. The latch circuit 120c may output a gate signal ‘gate’ including the turn on signal ‘ON’ and the turn off signal ‘OFF’ which are output to the gate by using the on trigger signal ‘ON trigger’ and the off trigger signal ‘OFF trigger’ as illustrated in FIG. 5. First, when the on trigger signal ‘ON trigger’ is generated, the gate signal ‘gate’ rises in the latch circuit 120c and thus is in a high state, such that the gate signal ‘gate’ may be the turn on signal ‘ON’.

Further, the latch circuit 120c keeps the gate signal ‘gate’ in the high state before the off trigger signal ‘OFF trigger’ is generated and then makes the gate signal ‘gate’ fall when the off trigger signal ‘OFF trigger’ is generated to enable the gate signal ‘gate’ to be in a low state, such that the gate signal ‘gate’ may be the turn off signal ‘OFF’. The on signal generator 120a and the off signal generator 120b may each control a generation timing of the on trigger signal ‘ON trigger’ and the off trigger signal ‘OFF trigger’ by using the sensing voltage VCS and the feedback voltage VFB. The on signal generator 120a and the off signal generator 120b alternately output the on trigger signal ‘ON trigger’ and the off trigger signal ‘OFF trigger’ and transfer the output trigger signals to the latch circuit 120c and the on signal generator 120a may transfer the on trigger signal ‘ON trigger’ to the latch circuit 120c to delay the turn off signal ‘OFF’ continuously generated to the turn on signal ‘ON’ which is kept long in the turn on signal ‘ON’. The on signal generator 120a controls the time for which the on trigger signal ‘ON trigger’ is transferred to enable the magnitude of the sensed signal to reach the preset value. Further, the on signal generator 120a may control the time for which the turn on signal ‘ON’ is kept until the magnitude of the sensed signal satisfies the preset conditions. The preset condition may be the condition that the magnitude of the sensing voltage VCS reaches the preset value and the condition that the feedback voltage VFB reaches the magnitude of the input power supply voltage Vin. That is, the on signal generator 120a keeps the turn on signal ‘ON’ when the magnitude of the driving current IL is smaller than a preset value ILmin even though the magnitude of the driving current IL detected by the sensing voltage VCS becomes the magnitude of current supplied from the input power supply voltage Vin to enable more driving current IL to flow in the inductor L. Further, the on signal generator 120a keeps the turn on signal ‘ON’ when the feedback voltage VFB is smaller than the magnitude of the input power supply voltage Vin even though the magnitude of the driving current IL detected by the sensing voltage VCS becomes the magnitude of the preset value ILmin to enable more driving current IL to flow. Further, the on signal generator 120a may further include an integrator and use the integrator to detect the time for which the turn on signal is kept longer. Here, the on signal generator 120a and the off signal generator 120b are illustrated as being separated from each other but are not limited thereto and therefore may share components. Further, the sensing voltage VCS may correspond to the magnitude of the driving current IL flowing in the inductor L.

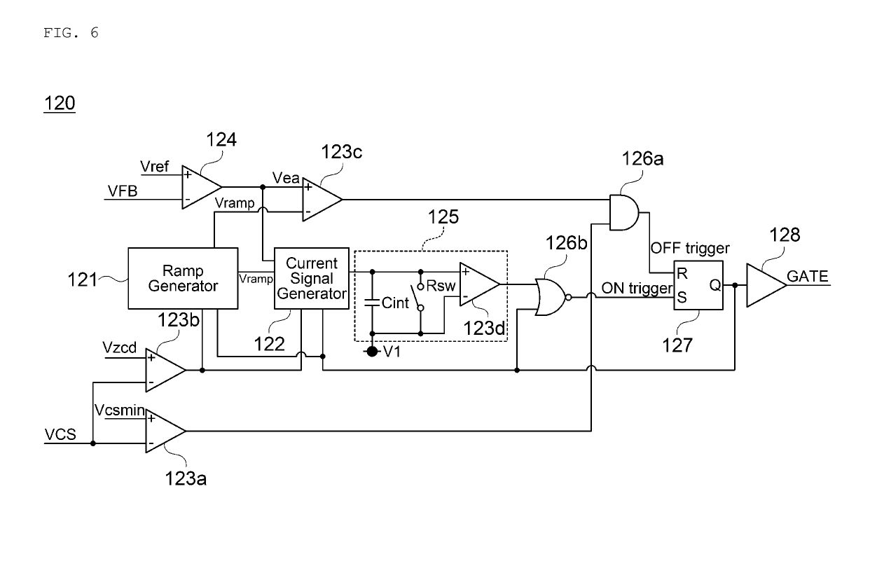

FIG. 6 is a structure diagram illustrating a second exemplary embodiment of a signal generator which is adopted in the PFC converter illustrated in FIG. 1.

Referring to FIG. 6, the signal generator 120 may include a ramp signal generator 121 which periodically generates a ramp signal having a predetermined slope, a current signal generator 122 which receives the turn on signal ‘ON’, the turn off signal ‘OFF’, and the sensing voltage VCS, respectively, to output a predetermined current, a capacitor Cint of which the first electrode is connected to the current signal generator 122 and the second electrode is connected to a predetermined voltage source V1 and reset by a reset switch RS, a first comparator 123a which compares the sensing voltage VCS corresponding to the current flowing in the inductor L with a first reference voltage VCSmin, a second comparator 123b which compares the sensing voltage VCS with a second reference voltage Vzcd, a third comparator 123c which compares a ramp signal Vramp with a third reference voltage Vea, a first operator 126a which receives output signals of the first comparator 123a and the third comparator 123c to perform an AND operation and outputs the turn off signal ‘OFF’ when the sensing voltage VCS is higher than the first reference voltage VCSmin and a waveform of the ramp signal Vramp is larger than the third reference voltage Vea, a fourth comparator 123d whose a positive (+) input terminal and a negative (−) input terminal are connected to one terminal and the other terminal of the capacitor Cint and generating the on trigger signal ‘ON trigger’ when the voltage charged in the capacitor Cint is lower than the predetermined value in the state in which a reset switch RSW is in a turned off state, a latch circuit 120c which receives a voltage of the output terminal of the first operator 126a and a voltage of the output terminal of the fourth comparator 123d to output the gate signal ‘gate’ including the turn on signal ‘ON’ and the turn off signal ‘OFF’, and a second operator 126b which receives the gate signal ‘gate’ output from the latch circuit 120c and the output signal of the fourth comparator 123d to perform an NOR operation. The latch circuit 120c may be an RS flip flop. Further, the capacitor Cint, the reset switch RSW, and the fourth comparator 123d may be included in the integrator 125.

Further, the signal generator 120 may include an error amplifier 124 which amplifies a difference between the voltage VFB applied to the load 140 and a fourth reference voltage Vref to generate the third reference voltage Vea. Further, the current signal generator 122 may be fed back with the gate signal ‘gate’ output from the latch circuit 120c and may receive the ramp signal generated from the ramp signal generator 121 and the output signal of the error amplifier 124.

Further, the second comparator 123b, the integrator 125, the current signal generator 122, and the second operator 126b may be included in the on signal generator 120a illustrated in FIG. 4 and the first comparator 123a, the third comparator 123c, and the first operator 126a may be included in the off signal generator 120b illustrated in FIG. 4. Further, the ramp signal generator 121 and the error amplifier 124 may be included in the on signal generator 120a and the off signal generator 120b. However, this is not limited thereto.

Describing the operation of the signal generator 120 configured as described above, the ramp signal generator 121 is connected to the output terminal of the latch circuit 127 and the output terminal of the second comparator 123b,the ramp signal generator 121 outputs the ramp signal having a predetermined slope when the on trigger signal ‘ON trigger’ is transferred from the latch circuit 127, the ramp signal keeps a predetermined voltage when the latch circuit 127 transfers the off trigger signal ‘OFF trigger’, and the ramp signal generator 121 may be reset when the voltage of the output terminal of the second comparator 123b is in a high state. That is, the ramp signal generator 123 may output a signal as illustrated in FIG. 7. Further, if it is determined by the second comparator 123b that the driving current IL does not flow, the ramp signal Vramp falls and thus may be 0. In this case, the second reference voltage Vzcd which is transferred to the second comparator 123b may be slightly smaller than 0V, but is not limited thereto. Further, if the driving current IL flowing in the inductor L meets the above Equation 2, the ramp signal Vramp may be again increased.

Further, the first comparator 123a compares the sensing voltage VCS corresponding to the magnitude of the driving current IL with the first reference voltage VCSmin and may output a high signal when the voltage corresponding to the magnitude of the driving current IL is smaller than the first reference voltage VCSmin. Further, the second comparator 123b compares the sensing voltage VCS corresponding to the magnitude of the driving current IL with the second reference voltage Vzcd and may output a high signal when the voltage corresponding to the magnitude of the driving current IL is larger than the second reference voltage Vzcd. Further, the third comparator 123c compares the third reference voltage Vea with the ramp signal Vramp and may generate the high signal when the magnitude of the ramp signal Vramp is larger than the third reference voltage Vea. Further, the signals of the first comparator 123a and the third comparator 123c may be transferred to the first operator 126a. Since the first operator 126a performs the AND operation, the first operator 126a may output the high signal only when each signal transferred from the first comparator 123a and the third comparator 123c is the high signal. Further, the high signal output from the first operator 126a may be the turn off signal ‘OFF’. That is, if the case when it is determined by the first comparator 123a that the driving current IL flowing in the inductor L is larger than the current corresponding to the first reference voltage VCSmin and the case when it is determined by the third comparator 123c that the ramp signal Vramp is larger than the third reference voltage Vea are satisfied, the turn off signal ‘OFF’ may be output from the first operator 126a. Here, the first reference voltage VCSmin may be a predetermined reference value and the third reference voltage Vea corresponds to the output voltage of the error amplifier 124 which amplifies the difference between the feedback voltage VFB and the fourth reference voltage Vref and may be a voltage corresponding to the average value of the current flowing in the load 140 and the input power supply voltage Vin as a voltage obtained by amplifying the difference between the fourth reference voltage Vref and the voltage applied to the load 140. Therefore, the signal generator 120 determines whether the condition that the driving current IL flowing in the inductor L is larger than the predetermined value is satisfied by using the first comparator 123a and determines whether the condition that the ramp signal reaches the magnitude of the input power supply voltage Vin is satisfied by using the third comparator 123c and may output the off signal only when the two conditions are satisfied by the first operator 126a. Here, the arrival conditions may include one coinciding with the magnitude and one exceeding the magnitude. Further, the signal generator 120 may use the integrator 125 to determine the timing when the turn on signal ‘ON’ is generated. The integrator 125 may integrate the current output from the current signal generator 122 to detect the magnitude of the driving current flowing in the inductor L for the turn on time of the switch SW which is kept long. Further, the integrator 125 may keep the turn off signal ‘OFF’ long by preventing the on trigger signal ‘ON trigger’ from being transferred for the time corresponding to the detected magnitude of the driving current. The integrator 125 configured as described above first turns on a reset switch RSW to initialize the capacitor Cint. Then, when the reset switch RSW is turned off and a current flows from the current signal generator 122 to one terminal of the capacitor Cint to which the current signal generator 122 is connected as illustrated in FIG. 7, and thus a current corresponding to the following Equation 3 may be transferred to the capacitor Cint.

Iint1=2Vramp−KVea (0˜Ton)

Iint2=KVramp−KVea (Ton˜Tzcd)

Iint3=−KVea (Tzcd˜tsw) [Equation 3]

In the above Equation 3, Int1 to Iint3 represent the first to third current signals which are output from the current signal generator 122, Vramp represents the ramp signal generated from the ramp signal generator 121, yea represents the third reference signal yea output from the error amplifier 124, Ton represents a turn on ending timing of the switch SW, Tzcd represents a timing when the magnitude of the driving current IL flowing in the inductor L is 0, Tsw is a timing when the switch SW is turned on, and K represents a constant.

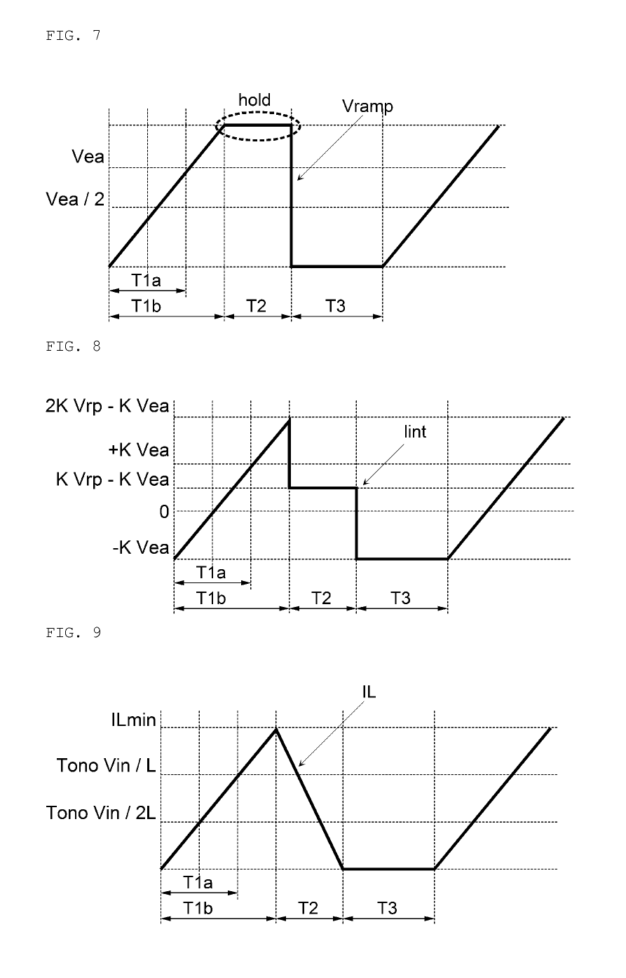

That is, the current signal generator 122 receives the output signal of the latch circuit 120c to output the first current signal corresponding to the ramp signal when the gate signal ‘gate’ output from the latch circuit 120c is in the high state, output a second current signal Iint2 when the gate signal ‘gate’ output from the latch circuit 120c is in a low state, and output a third current signal Iint3 when the magnitude of the sensing voltage VCS reaches the predetermined value or more, and an output signal of a fourth comparator 123d is in a low state when the voltage charged in the capacitor Cint is equal to or less than a predetermined value by the third current signal Iint3 and thus the switch SW may be again turned on. Here, the predetermined value may be “0”. Describing again, the capacitor Cint may be charged with the corresponding first current signal Int1 in a first period T1b for which the reset switch SW is turned off and the switch SW keeps a turn on state. Further, the capacitor Cint may be charged with the corresponding second current signal Iint2 in a second period T2 till the switch SW is turned off and thus the magnitude of the driving current IL flowing in the inductor L is a predetermined value “0”, in the period for which the switch SW keeps the turn off state. Further, the capacitor Cint may be charged with the corresponding third current signal Iint 3 in a third period T3 for which the driving current IL does not flow in the inductor IL. As such, the driving current IL may flow as illustrated in FIG. 8 by the change in magnitude of the current stored in the capacitor Cint over time. That is, the driving current IL flowing in the inductor L is increased as the lamp waveform in the first period T1b, the driving current IL flowing in the inductor L is decreased in the second period T2, and the driving current IL does not flow in the inductor L in the third period T3. An average of the current flowing in the inductor L in the first period T1b to the third period T3 may satisfy the above Equation 2.

Further, since the output terminal of the integrator 125 is input to one terminal of the second operator 126b and the gate signal ‘gate’ output from the latch circuit 120c is fed back and thus is input to the other terminal of the second operator 126b, the output signal of the integrator 125 and the output signal of the latch circuit 120c are subjected to a NOR operation, such that the turn on signal may be transferred to the latch circuit 120c only when both of the two signals are low. That is, the on trigger signal ‘ON trigger’ may be transferred to the latch circuit 120c only when the output signal of the integrator 125 is in a low state and the gate signal ‘gate’ of the latch circuit 120c keeps a low state. Further, the current signal generator 122 may fed back with the output signal of the latch circuit 120c and may receive the output signal of the first comparator 123a. Further, the current signal generator 122 may be operated by recognizing the first period T1b when the gate signal ‘gate’ of the latch circuit 120c is the turn on signal, recognizing the second period T2 or the third period T3 when the output signal of the latch circuit 120c is the turn off signal, determining by the second comparator 123b that the driving current IL does not flow in the inductor L to determine the second period T2 when the driving current IL flows in the inductor L, and determines the third period T3 when the driving current IL does not flow in the inductor L. Further, the ramp signal generator 121 is connected to the output terminal of the second comparator 123b to reset the ramp signal Vramp if it is determined by the second comparator 123b that the driving current IL does not flow in the inductor L.

As set forth above, according to the signal generator and the PFC converter using the same in accordance with the exemplary embodiments of the present invention, it is possible to save power consumption by increasing the power factor in the light load.

The method of operating a signal generator according to the exemplary embodiment of the present invention may be implemented as a program command type that may be performed through various computer units and may be recorded in a computer readable medium. The computer-readable recording medium may include a program command, a data file, a data structure or the like, alone or a combination thereof. The program commands recorded in the computer-readable recording medium may be especially designed and constituted for the present invention or be known to those skilled in a field of computer software. An example of the computer readable recording medium may include magnetic media such as hard disk, floppy disk, magnetic tape, and the like, optical media such as CD-ROM, DVD, and the like, magneto-optical media such as floptical disk, and hardware devices specially configured to store and perform program commands such as ROM, RAM, flash memory, and the like. Examples of the program commands may include a high-level language code capable of being executed by a computer using an interpreter, or the like, as well as a machine language code made by a compiler. The hardware device may be constituted to be operated as one or more software modules in order to perform the action according to the present invention, and vice versa.

In claims in the present specification, elements represented as a means for performing a specific function include any scheme performing the specific functions and the elements may include a combination of circuit elements performing the specific function or software in any form including firmware, microcode, and the like which are coupled with a circuit suitable to perform software for performing the specific function.

In the present specification, ‘one exemplary embodiment’ of principles of the present disclosure and names for various changes of the expression mean that specific features, structures, characteristics, and the like, associated with the exemplary embodiment are included in at least one exemplary embodiment of the principle of the present disclosure. Therefore, the expression ‘one exemplary embodiment’ and any other modification examples disclosed throughout the present specification do not necessarily mean the same exemplary embodiment.

In the present specification, ‘connected’ or ‘connecting’ and names for various modifications of these expressions are used as a meaning including ones directly connected to other components or ones indirectly connected thereto through other components. Unless explicitly described to the contrary, a singular form includes a plural form in the present specification. In addition, components, steps, operations, and elements mentioned as ‘comprise’ or ‘comprising’ in the present specification do not exclude the existence or addition of one or more other components, steps, operations, and elements, and apparatuses.

What is claimed is:

1. A PFC converter, comprising:
a converter unit including an inductor and a switch which switches a flow of driving current in the inductor by a turn on or turn off operation; and
a signal generator outputting a turn on signal or a turn off signal switching the switch and when a magnitude of the driving current is smaller than a preset value, keeping the turn on signal long to enable the magnitude of the driving current to reach the preset value.

2. The PFC converter according to claim 1, wherein the signal generator includes an on signal generator which generates an on trigger signal by a sensing voltage sensing the driving current and a feedback voltage corresponding to an output voltage of the converter unit and an off signal generator which generates an off trigger signal in response to the sensing voltage, and
the signal generator outputs the turn on signal when the on trigger signal is input and outputs the turn off signal when the off trigger signal is input.

3. The PFC converter according to claim 2, wherein the on signal generators alternately output the on trigger signals and delay and output an on trigger signal generated after the turn on signal kept long among the on trigger signals.

4. The PFC converter according to claim 2, wherein the on signal generator includes an integrator which calculates a period for which the turn on signal is kept long.

5. The PFC converter according to claim 4, wherein the integrator receives and integrates first to third current signals over time and outputs the on trigger signal when the integrated value is equal to or less than a predetermined value.

6. The PFC converter according to claim 5, wherein the on signal generator further includes a current signal generator which outputs the first to third current signals and the current signal generator outputs the first current signal when the turn on signal is fed back, outputs the second current signal when the turn off signal is fed back, and outputs the third current signal when the sensing voltage is equal to or less than a predetermined value.

7. The PFC converter according to claim 6, wherein the on signal generator further includes a second comparator and the second comparator compares a second reference voltage with the sensing voltage to sense the magnitude of the driving current.

8. The PFC converter according to claim 2, wherein the off signal generators alternately output the off trigger signals and delay and output an off trigger signal transferred after the turn on signal kept long among the off trigger signals as much as a period for which the turn on signal is kept long.

9. The PFC converter according to claim 2, wherein the off signal generator outputs the off trigger signal when a magnitude of the sensing voltage is equal to or more than a preset value and a magnitude of a ramp signal reaches a voltage corresponding to a magnitude of an input current.

10. The PFC converter according to claim 9, wherein the off signal generator includes a first comparator which compares a first reference voltage with the sensing voltage and a third comparator which compares the ramp signal with a third reference voltage corresponding to the feedback voltage.

11. The PFC converter according to claim 10, wherein the off signal generator further includes an error amplifier which amplifies a difference between the feedback voltage and a fourth reference voltage to generate the third reference voltage.

12. The PFC converter according to claim 10, wherein the off signal generator further includes a first operator which receives the outputs of the first comparator and the third comparator, respectively, to perform an AND operation so as to output the turn off signal.

13. The PFC converter according to claim 2, wherein the signal generator further includes latch circuit which outputs the turn on signal after the on trigger signal is input and before the off trigger signal is input and outputs the turn off signal after the off trigger signal is input and before the on trigger signal is input.

14. The PFC converter according to claim 1, wherein the signal generator includes:
a first comparator comparing a sensing voltage sensing the driving current with a first reference voltage;
a second comparator comparing the sensing voltage with a second reference voltage;
a third comparator comparing a ramp signal having a predetermined slope with a third reference voltage;
a first operator receiving output signals of the first comparator and the third comparator to perform an AND operation and outputting an off trigger signal when the sensing voltage is higher than the first reference voltage and a magnitude of the ramp signal is larger than the third reference voltage;
a capacitor having a first electrode receiving a current signal corresponding to the ramp signal and a second electrode connected to a predetermined voltage source and reset by a reset switch;
a fourth comparator having a positive (+) input terminal and a negative (−) input terminal connected to one terminal and the other terminal of the capacitor, respectively and generating an on trigger signal when a voltage charged in the capacitor is lower than a predetermined value in the state in which the reset switch is turned off;
a latch circuit receiving a voltage of an output terminal of the first operator and a voltage of an output terminal of the fourth comparator and selectively outputting the voltages of the output terminals; and
a second operator being fed back with an output signal of the latch circuit and receiving an output signal of the fourth comparator to perform a NOR operation.

15. The PFC converter according to claim 14, wherein the signal generator further includes:
a current signal generator outputting the current signal, receiving the turn on signal to output a first current signal corresponding to the ramp signal, receiving the turn off signal to output a second current signal smaller than the first current signal, and outputting a third current signal when a magnitude of the sensing voltage is equal to or less than a predetermined value and making the voltage charged in the capacitor be equal to or less than the predetermined value by the third current signal.

16. The PFC converter according to claim 15, the signal generator further includes:
a ramp signal generator connected to an output terminal of the latch circuit and an output terminal of the second comparator, outputting a ramp signal when the turn on signal is transferred from the latch circuit, keeping a voltage of the ramp signal when the turn off signal is transferred from the latch circuit, and reset when the voltage of the output terminal of the second comparator is a predetermined value.

17. The PFC converter according to claim 15, wherein the signal generator further includes:
an error amplifier amplifying a difference between a feedback voltage corresponding to the output voltage of the converter unit and a fourth reference voltage to generate the third reference voltage.

18. The PFC converter according to claim 15, wherein the current signal generator is operated by receiving the turn on signal or the turn off signal output from an output terminal of the latch circuit, the ramp signal, and the output signal of the first comparator.

19. The PFC converter according to claim 14, wherein the signal generator further includes a ramp signal generator which generates the ramp signal and the ramp signal generator receives an output signal of the second comparator to output the ramp signal having a predetermined slope when the magnitude of the current flowing in the inductor is smaller than the preset value, keeps a peak value of the ramp signal when the magnitude of the current flowing in the inductor is larger than the preset value, and stops driving when a magnitude of the sensing voltage is smaller than a predetermined value to prevent the ramp signal from being output.

20. The PFC converter according to claim 1, wherein the converter unit further includes:
a rectifier performing full-wave rectification on AC power supplied as the input power and supplying the full-wave rectified AC power to the inductor and the inductor is supplied with the current wherein the current is supplied.

21. The PFC converter according to claim 20, wherein the rectifier includes a bridge diode and a rectifier capacitor storing a voltage transferred from the bridge diode.

22. A signal generator controlling a turn on signal and a turn off signal to control a flow of driving current, comprising:
an on signal generator outputting an on trigger signal in response to a sensing voltage sensing the driving current;
an off signal generator outputting an off trigger signal in response to the sensing voltage; and
a latch circuit outputting the turn on signal when the on trigger signal is input and outputting the turn off signal when the off trigger signal is input,
wherein the off signal generator delays the off trigger signal when a magnitude of the sensing voltage is smaller than a preset value and transfers the delayed off trigger signal to the latch circuit to enable the magnitude of the sensing voltage to reach the preset value.

23. The signal generator according to claim 22, wherein the on signal generator delays the on trigger signal in response to a time for which the off trigger signal is delayed and transfers the delayed on trigger signal to the latch circuit.

24. The signal generator according to claim 22, wherein the on signal generator alternately outputs the on trigger signals and delays and outputs an on trigger signal generated after the turn on signal kept long among the on trigger signals.

25. The signal generator according to claim 22, wherein the off signal generators alternately output the off trigger signals and delay and output an off trigger signal transferred after the turn on signal kept long among the off trigger signals as much as a period for which the turn on signal is kept long.

26. The signal generator according to claim 22, wherein the off signal generator outputs the off trigger signal when the magnitude of the sensing voltage is equal to or more than the preset value and a magnitude of a ramp signal reaches a voltage corresponding to a magnitude of an input current.

27. The signal generator according to claim 22, wherein the latch circuit outputs the turn on signal after the on trigger signal is input and before the off trigger signal is input and outputs the turn off signal after the off trigger signal is input and before the on trigger signal is input.

28. A signal generator controlling a turn on signal and a turn off signal to control a flow of driving current, comprising:
a first comparator comparing a sensing voltage sensing the driving current with a first reference voltage;
a second comparator comparing the sensing voltage with a second reference voltage;
a third comparator comparing a ramp signal having a predetermined slope with a third reference voltage;
a first operator receiving output signals of the first comparator and the third comparator to perform an AND operation and outputting a signal corresponding to the turn off signal when the sensing voltage is higher than the first reference voltage and a magnitude of the ramp signal is larger than the third reference voltage;
a capacitor having a first electrode receiving a current signal corresponding to the ramp signal and a second electrode connected to a predetermined voltage source and reset by a reset switch;
a fourth comparator having a positive (+) input terminal and a negative (−) input terminal connected to one terminal and the other terminal of the capacitor, respectively and generating a signal corresponding to the turn on signal when a voltage charged in the capacitor is lower than a predetermined value in the state in which the reset switch is turned off;
a latch circuit receiving a voltage of an output terminal of the first operator and a voltage of an output terminal of the fourth comparator and selectively outputting the voltages of the output terminals; and
a second operator being fed back with an output signal of the latch circuit and receiving an output signal of the fourth comparator to perform a NOR operation.

29. The signal generator according to claim 28, further comprising:
a current signal generator outputting the current signal, receiving an on trigger signal to output a first current signal corresponding to the ramp signal, receiving an off trigger signal to output a second current signal smaller than the first current signal, and outputting a third current signal when a magnitude of the sensing voltage is equal to or less than a predetermined value and making the voltage charged in the capacitor be equal to or less than the predetermined value by the third current signal.

30. The signal generator according to claim 28, further comprising:
a ramp signal generator connected to an output terminal of the latch circuit and an output terminal of the second comparator, outputting the ramp signal when the turn on signal is transferred from the latch circuit, keeping a voltage of the ramp signal when the turn off signal is transferred from the latch circuit, and reset when a voltage of the output terminal of the second comparator is a predetermined value.

31. The signal generator according to claim 28, further comprising:
an error amplifier amplifying a difference between a feedback voltage and a fourth reference voltage to generate the third reference voltage.
